(19) United States
(12) Patent Application Publication
(10) Pub. No.: US 2021/0056276 A1
(43) Pub. Date: Feb. 25, 2021

(54) APPARATUS AND METHOD FOR IMPROVED BIOMETRIC SENSING

(71) Applicant: QUALCOMM Incorporated, San Diego, CA (US)

(72) Inventors: Yipeng LU, Davis, CA (US); Jessica Liu STROHMANN, Cupertino, CA (US); Ila BADGE, San Jose, CA (US); Hrishikesh Vijaykumar PANCHAWAGH, Cupertino, CA (US); Tsongming KAO, Sunnyvale, CA (US)

(21) Appl. No.: 16/544,681

(22) Filed: Aug. 19, 2019

(51) Int. Cl. G06K 9/00

(52) U.S. Cl. CPC G06K 9/0002; G06F 21/32; G06K 9/00087

(57) ABSTRACT

A device and method for improved sensing with a biometric sensor assembly such as an ultrasound fingerprint sensor using an anti-fingerprint, oleophobic, or hydrophobic coating applied to a surface above the biometric sensor assembly. The coating improves the mechanical coupling of a human finger to the surface, helping to reduce acoustic loss through the finger to surface interface, improving at least the false-rejection ratio.

### FIELD

The present disclosure relates to the field of substrates and substrate coating materials with hydrophobic/oleophobic coatings for the purpose of biometric sensing including fingerprint sensing.

### BACKGROUND

Surfaces for touch screens with hydrophobic/oleophobic coatings are in common use. Modern mobile devices typically have a glass touch screen which overlays a display. There is a problem where oils and moisture from fingerprints transfer to the glass touch screen and create visual artifacts when viewing the display.

Coating a touch screen with a hydrophobic/oleophobic coating makes the surface resistant to fingerprint transfer and moisture haze. Other mobile device surfaces do not have as pressing a need for an anti-fingerprint coating as does the touch screen, because they do not rely on light transmission through them, and typically have other coatings for the purposes of coloration or enhanced surface hardness.

Biometric sensors beneath mobile device surfaces other than the touch glass may suffer from the coatings applied thereto, such as oxide or paint layers. There currently exists an unmet need to improve the performance of biometric sensors beneath mobile device surfaces other than the touch glass.

### SUMMARY

Techniques herein are provided for enabling improved ultrasonic fingerprint sensing apparatuses.

An example of an apparatus for ultrasonic fingerprint sensing may comprise a device housing area, comprising a device housing area substrate and a device housing area coating, wherein the device housing area substrate is not configured to transmit light from a display, wherein the device housing area coating comprises an anti-fingerprint coating bonded to an outer surface of the device housing area substrate; and a biometric sensor assembly, wherein the biometric sensor assembly comprises an ultrasound fingerprint sensor, and wherein the biometric sensor assembly is operably configured to sense a biometric characteristic of an object applied to the device housing area.

An exemplary method for ultrasonic fingerprint sensing may comprise sensing, by a biometric sensor assembly, a biometric characteristic of an object applied to a device housing area, wherein the biometric sensor assembly is coupled to the device housing area, comprising a device housing area substrate and a device housing area coating, wherein the device housing area substrate is not configured to transmit light from a display, wherein the device housing area coating comprises an anti-fingerprint coating bonded to an outer surface of the device housing area substrate, wherein the biometric sensor assembly comprises an ultrasound fingerprint sensor, and wherein the biometric sensor assembly is operably configured to sense a biometric characteristic of an object applied to the device housing area, and authenticating a user based on the sensed biometric characteristic of the object.

### BRIEF DESCRIPTION OF THE DRAWINGS

FIG. 1 shows a representative example of a side-view cutaway of an apparatus for improved biometric sensing, according to some implementations.

FIG. 2 is a plot of an acoustic transmission ratio versus a coating thickness in an exemplary embodiment.

FIG. 3A shows the effects of an exemplary oleophobic or hydrophobic low surface-energy coating on a substrate.

FIG. 3B is a diagram of exemplary characteristic of a water droplet on a hydrophilic surface versus a hydrophobic surface.

FIG. 4A is a data plot of false rejection rate (FRR) and false acceptance rate (FAR) for biometric authentication systems with different coatings applied to a substrate.

FIG. 4B is a data plot of number of acquired images needed to achieve high image quality (IQ) for matching or authentication according to some implementations.

FIG. 5 is a representative side-view perspective of an apparatus for improved biometric sensing, according to some embodiments.

FIG. 6 shows an example of an apparatus for improved biometric sensing, being used to sense a biometric characteristic, according to some embodiments.

FIG. 7 shows an exemplary flow diagram of sensing a biometric characteristic, according to some implementations.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a biometric system as disclosed herein. In addition, it is contemplated that the described implementations may be included in or associated with a variety of electronic devices, and device housings associated with devices such as, but not limited to: mobile telephones, multimedia Internet enabled cellular telephones, mobile television receivers, wireless devices, smartphones, smart cards, wearable devices such as bracelets, armbands, wristbands, rings, headbands, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices.

The teachings herein also may be used in applications such as, but not limited to, electronic switching devices, motion-sensing devices, parts of consumer electronics products, steering wheels, door handle mechanisms, or other automobile parts, liquid crystal devices, electrophoretic devices, and electronic test equipment. Thus, the teachings are not intended to be limited to the implementations depicted solely in the Figures, but instead have wide applicability as will be readily apparent to one having ordinary skill in the art.

Various implementations disclosed herein may include a biometric system, such as a biometric sensor or fingerprint sensor, that is capable of ultrasonic imaging of resultant acoustic wave generation. Some such implementations may be capable of obtaining images from bones, muscle tissue, blood, blood vessels, veins, capillaries, and/or other sub-epidermal features. As used herein, the term “sub-epidermal features” may refer to any of the tissue layers that underlie the epidermis, including the dermis, the subcutis, etc., and any blood vessels, lymph vessels, sweat glands, hair follicles, hair papilla, fat lobules, etc., that may be present within such tissue layers. Some implementations may be capable of biometric authentication that is based, at least in part, on image data obtained via ultrasonic imaging. In some examples, an authentication process may be based on image data obtained via photoacoustic imaging and also on image data obtained by transmitting ultrasonic waves and detecting corresponding reflected ultrasonic waves.

Herein, a coating may include a surface treatment, applied by itself or with an adhesion promotor layer. A coating may include multiple layers of differing materials. A layer or layers of a coating may be applied by a plasma treatment, vapor deposition, dipping, painting, or other methods known in the art for applying a coating or layer to a surface.

Generally, devices for fingerprint sensing operate by detecting aspects of a object, such as a biometric object, when an object, finger or other body part is placed against a surface of a substrate. Depending on the type of biometric detecting technology employed, there may exist different requirements and limitations for the aforementioned surface and substrate. Optical biometric detecting technology (alternatively known as optical fingerprint technology), for example, requires an optically transparent substrate with a surface that does not interfere with light reflected from the ridges and valleys of a fingerprint. Optical fingerprint sensors typically use a glass substrate, for the optical transparency characteristics, and because the surface of the glass is normally smooth, this provides a good surface for fingerprint detection without need for any extra treatment or coating applied to the surface of the glass substrate.

However, ultrasonic biometric detecting technology (alternatively known as biometric fingerprint detecting technology) has much more flexibility with respect to the choice of substrate. Ultrasonic fingerprint sensors may be applied to glass, similar to optical fingerprint sensors, but also to metal, plastic, ceramic, and other opaque materials that do not allow light transmission as does glass. Despite the myriad additional surfaces to which ultrasonic sensors may be applied, the surface characteristic of the substrate/finger interface may not be optimal for ultrasonic fingerprint detection. These opaque surfaces may not have the same typically smooth surface characteristics as glass; they may be rougher, and thus may have less contact area with ridges of fingerprints or palmprints. Ultrasonic fingerprint sensing relies on adequate contact area with the aforementioned ridges, thus rougher surfaces have a negative impact on ultrasonic fingerprint sensing.

In North America, surface roughness is usually measured by an algorithm that measures average length between peaks and valleys and the deviation from the mean line on a whole surface within the sampling length. The average roughness (RA) averages these peaks and valleys and removes outliers. The surface of glass may have an RA of around 1 nm, whereas anodized aluminum may have an RA of 200 nm or more, and this poses difficulties for fingerprint sensing methods under the aluminum substrate. Other substrates, such as other metals or plastics, may have similarly rough surfaces. The roughness of these surfaces distorts the image received by an ultrasonic fingerprint sensors. A coating may thus be applied to these surfaces, reducing the roughness of the surface, thus improving the surface area of contact between a biometric object and the surface, thus improving acoustic transmission through the substrate, thus providing the advantage of increasing the image quality received by the ultrasonic fingerprint sensor.

The impact of surface roughness may also impact the false rejection rate (FRR) of biometric authentications. A false rejection is when an authorized user applies his/her validated biometric attributes to a device, but the device fails to recognize the user as authorized. It is desirable to reduce false rejection rates in biometric devices. A further advantage of applying a coating to the surface of the substrate of a device housing area with a biometric sensor assembly is the reduction of the FRR via increased image quality.

Human skin has biometric characteristics that vary from person to person—one such characteristic is the moisture content of the skin surface. These characteristics may also change as a person ages. For example, as humans get older, the outer epidermal layer of their fingers gets dryer. When applied to a surface of a substrate of a device housing area with a biometric sensor assembly, a dry finger will have lower surface contact between the finger ridges and the surface of the substrate. This can produce “leopard like” spot defects in a fingerprint image produced by a biometric measurement, such spots appearing as discontinuities in what may actually be continuous ridges. By applying a coating to the surface of the substrate of the housing area with a biometric sensor assembly, there will be an increase in the surface contact area between the finger ridges and the surface of the substrate, thus a fingerprint image produced by a biometric measurement from the sensor assembly will have the advantage of reduced spot defects for dry fingers.

Similarly, colder fingers will have lower surface contact between the finger ridges and the surface of the substrate relative to warmer fingers. This can also produce “leopard-like” spot defects in a fingerprint image produced by a biometric measurement. By applying a coating to the surface of the substrate of the housing area with a biometric sensor assembly, there will be an increase in the surface contact area between the finger ridges and the surface of the substrate, thus a fingerprint image produced by a biometric measurement from the sensor assembly will have the advantage of reduced spot defects for cold fingers.

A surface coating may also act as an acoustic matching layer. Acoustic transmissions will reflect at the boundaries of materials with differing acoustic impedances. Poor acoustic matching results in lost energy, and thus poorer biometric image quality. By adjusting the thickness of the coating, acoustic reflections at the coating to surface interface may be reduced, thus increasing the acoustic transmission through the substrate and providing the benefit of better biometric image quality.

In an implementation, an electronic device, which may be a mobile device, may have a housing area, such as a case which contains the electronic elements. The housing area may comprise a substrate, such as glass, plastic, wood, metal or any other suitable material. Additionally, the substrate may not be configured to transmit light from a display, and thus may be opaque, and may also have a rougher surface, as described above. The device housing area may be coated with a coating. The coating may be an oleophobic and/or hydrophobic coating, such as an anti-fingerprint coating. The coating may be bonded to the outer surface of the device housing area substrate, or on a separate component which may not be part of the housing, such as a separate button in the front, back, or on the side of the phone. The device housing area may be considered to include a button, whether the button is a separate component substantially connected to the device housing, or whether the button exists underneath the outer surface of the device housing. Such a button may or may not provide tactile feedback when pressed or touched. A biometric sensor assembly, such as an ultrasonic fingerprint sensor, may be situated on the opposite side of the housing area substrate to the coating. The biometric sensor assembly may be configured to sense a biometric characteristic, such as a fingerprint, of an object applied to the device housing area, such as a fingerprint or palmprint, when the biometric object is applied to the housing area.

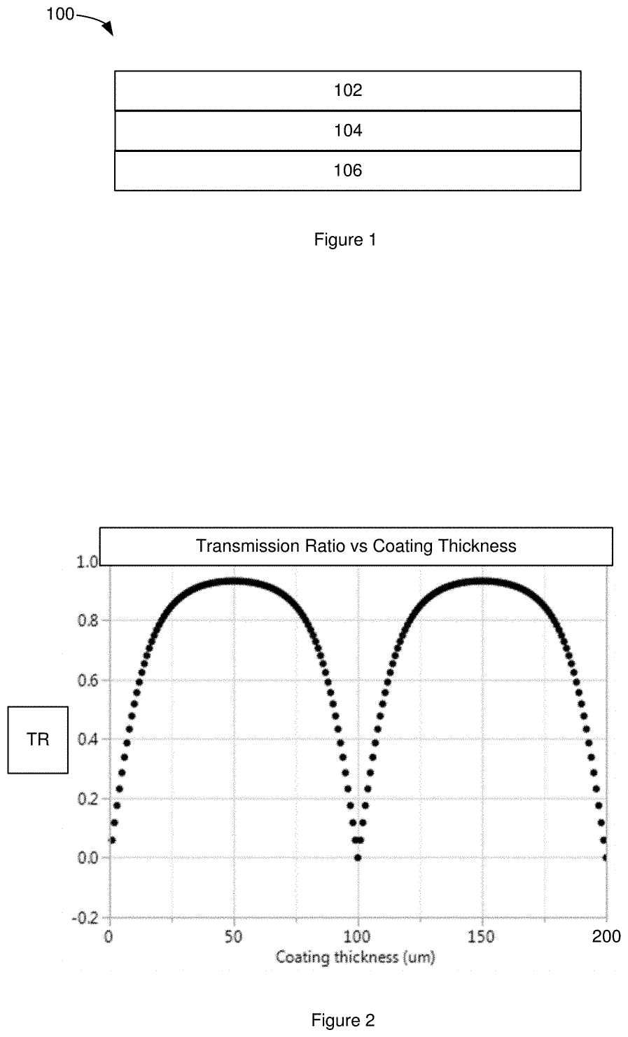

Figure A shows an exemplary embodiment of an improved apparatus for biometric sensing 100. A biometric sensor assembly 106 is disposed under a substrate 104, which is disposed under a coating 102. The substrate 104 may be part of a device housing, such as the chassis or outer casing of a mobile device. The substrate 104 together with the coating 102 may have an area, with a length and a width, that as part of a device housing may be termed “a device housing area.” The various layers in FIG. 1A are not shown to scale. The biometric sensor assembly 106 may be an ultrasonic sensor, such as an ultrasonic fingerprint sensor. The biometric sensor assembly 106 may be any other type of biometric sensor which does not rely on a transparent substrate to perform biometric measurements. The substrate 104 may be composed of glass, plastic, wood, ceramic, metal or any other suitable material. The substrate 104 may be an anodized aluminum layer, a titanium aluminum nitride layer, or an aluminum titanium nitride layer. The substrate 104 may not be configured to transmit light from a display, such as where the substrate 104 is an opaque material, and/or does not have a display operably positioned to transmit light through the substrate 104. The coating 102 may include a surface treatment, applied by itself or with an adhesion promotor layer. The coating 102 may include multiple layers of differing materials. A layer or layers of the coating 102 may be applied by a plasma treatment, vapor deposition, dipping, painting, or other suitable methods of applying a coating to a surface. The coating 102 may be a hydrophobic and/or oleophobic coating, including but not limited to Teflon, MC 157, Nanoslic® NS110, Henkel® Bonderite S-FN1000, DFC8404, MC-161P, MC-160P, MC-156P, H-301P, H-300P, Iwata® 4926-Lph80-104G, Micro Solution Pro Guard® F2AF (Fluoropolymer Coating), Liquid Armor Plus®, FluoroSyl® FSD-2500, Dow Corning® 2634 Coating, Nanoslic® NS50, Nanoslic® NS100, Nanoslic® NS200, NANOMYTE_SR100EC®.

FIG. 2 shows one effect of a hydrophobic/oleophobic coating thickness on the transmission ratio of an acoustic signal through a substrate. For a given wavelength of an ultrasonic emission, for example, the coating thickness can cause an efficient transmission of acoustic energy (at 50 um) or an inefficient transmission of acoustic energy (at 100 um).

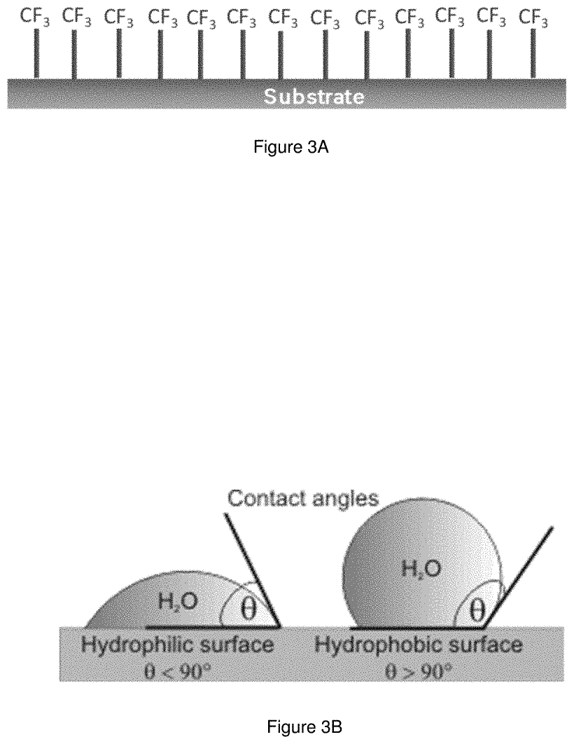

FIG. 3A shows an example of fluorinated polymers applied to a surface. Hydrophobic/Oleophobic coating materials typically have —CF₃ as a chain termination group. This is one example of a coating with low surface energy that has hydrophobic and oleophobic properties. Besides that, the silica-based gel coatings are perhaps most cost effective. They are easy to apply either by dipping the object into the gel or via aerosol spray, however they may not last very long. In contrast, oxide polystyrene composites are more durable but costly. Lately, carbon nano-tubes have been developed to imbue surfaces with hydrophobic and oleophobic properties.

FIG. 3B is a diagram of exemplary characteristic of a water droplet on a hydrophilic surface versus a hydrophobic (and/or oleophobic) surface. As shown, a hydrophilic surface produces a smaller contact angle with a water droplet, less than 90 degrees. A hydrophobic surface produces a larger contact angle with a water droplet, greater than 90 degrees. An example of a hydrophilic surface would be a surface without a hydrophobic coating, such as oxidized aluminum. A hydrophobic surface would be a substrate which has a hydrophobic coating applied, wherein the surface is the outer layer comprising the hydrophobic coating.

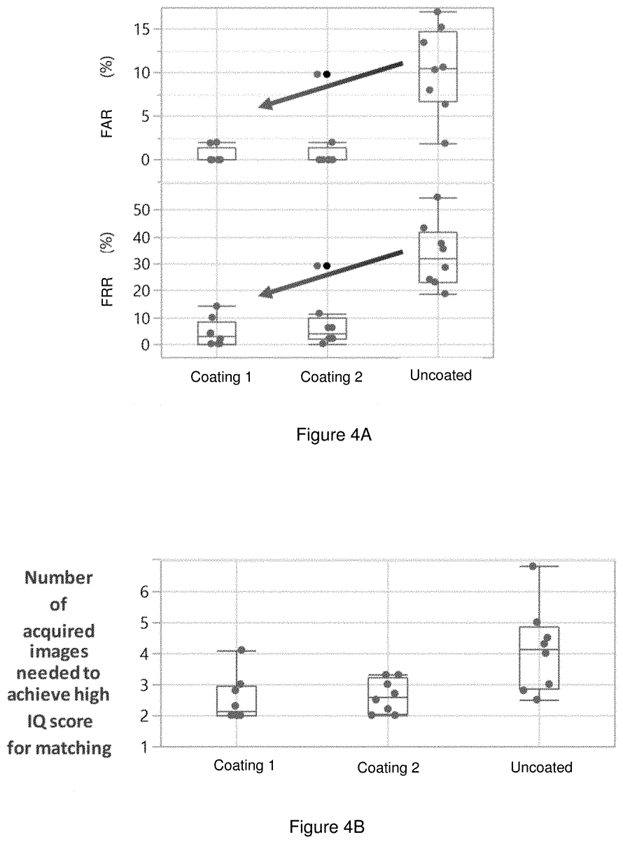

FIG. 4A shows two effects of applying two different hydrophobic/oleophobic coatings to a substrate. The chart shows two metrics. The FAR indicates the false acceptance rate which is the measure of the probability that a biometric sensor system will incorrectly accept an access attempt by an unauthorized user. The FRR indicates the false rejection rate, or the measure of the probability that the biometric sensor system will incorrectly reject an access attempt by an authorized user. In an experiment, repeated measurements by a biometric sensor assembly under an uncoated substrate will produce an FAR around 10%, and an FRR around 30%, on average. However, with hydrophobic/oleophobic coatings applied, it is shown that the FAR is reduced to near 0% and the FRR is reduced to under 5%.

FIG. 4B shows two effects of applying two different hydrophobic/oleophobic coatings to a substrate. The chart shows the metric of number of biometric images that need to be acquired to achieve a high enough image quality (IQ) score to match to an authorized user. In an experiment, repeated measurements by a biometric sensor assembly under an uncoated substrate requires around 4 images on average to achieve a high enough IQ score, whereas with hydrophobic/oleophobic coatings applied, a coated substrate requires fewer than 3 images on average to achieve a high enough IQ score. This dramatically reduces the latency of the system.

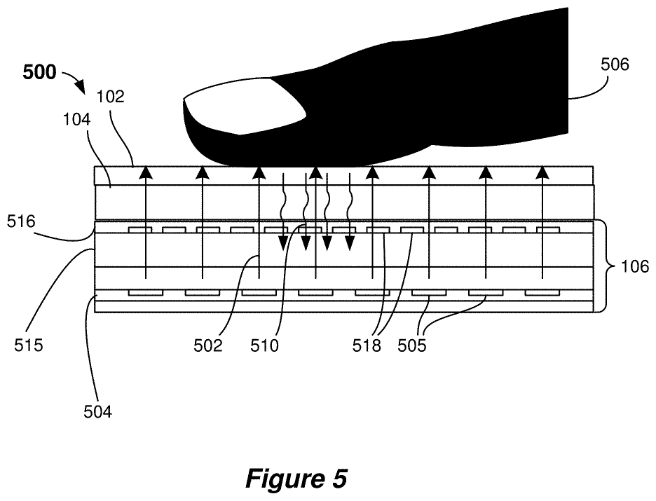

FIG. 5 shows an exemplary embodiment of an apparatus 500, including a biometric sensor assembly 106, substrate 104, and coating 102, where the biometric sensor assembly 106 is an ultrasonic fingerprint sensor stack. Here, the fingerprint of the finger 506 is being ensonified by ultrasonic waves 502. In this example, the apparatus 500 includes an ultrasonic-energy emitter layer 504, which may include an array or sheet of ultrasound-emitting material, such as PVDF (Polyvinylidene fluoride or polyvinylidene difluoride), or individual sources such as PMUTs (piezoelectric ultrasound micromachined transducers). Substrate 515 may comprise a thin-film transistor (TFT) substrate. In some instances, the incident acoustic wavelength, wavelengths and/or wavelength range(s) may be selected to trigger or cause reflected acoustic wave emissions primarily from a particular type of material, such as blood, blood vessels, other soft tissue, or bones. In an alternative, the incident acoustic wavelength, wavelengths and/or wavelength range(s) may be selected in order to accommodate the thickness of the coating 102.

In this example, incident ultrasound waves 502 have been transmitted from the ultrasonic sources 505 of the biometric sensor assembly 106 through the biometric sensor assembly 106, substrate 104, and coating 102, and to/into an overlying finger 506. The incident ultrasonic waves ensonify the overlying finger 506 and cause reflections 510 to be sent back down into the biometric sensor assembly 106. In alternative implementations, the ultrasonic-energy emitter layer 504 may be coupled directly to the substrate 104. In other alternative implementations, the ultrasonic-energy emitter layer 504 may comprise a number of piezoelectric micromachined ultrasonic transducers (PMUTs).

In an implementation, substrate 104 is coupled to an ultrasonic receiver array 516. In some implementations, sensor pixels 518 of the ultrasonic receiver array 516 may comprise PMUTs. In an alternative embodiment, the PMUTs may also be configured to transmit ultrasonic energy. In some implementations, the ultrasonic receiver array 516 and associated circuitry may be formed on or in a glass, plastic or silicon substrate 515.

In an example, in the portion of the apparatus 500 that is shown in FIG. 5, the ultrasonic-energy emitter layer 504 may or may not be part of the ultrasonic receiver array 516, depending on the particular implementation. In some examples, the ultrasonic receiver array 516 may include PMUT or CMUT (capacitive micromachined ultrasonic transducer) elements that are capable of transmitting and receiving ultrasonic waves, and the piezoelectric receiver layer 516 may be replaced with an acoustic coupling layer, or may be eliminated.

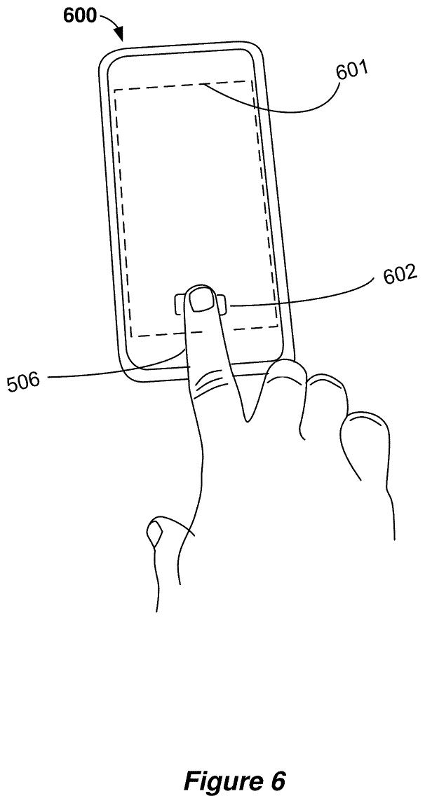

FIG. 6 shows an exemplary mobile device 600, shown in the figure with display 601 facing away. A device housing area 602 is shown on the backside of the mobile device 600. The device housing area 602 may comprise an apparatus for ultrasonic fingerprint sensing 500 (not shown). A finger 506 may be placed onto the backside of the mobile device 600 onto the device housing area 602 in order for the device to perform a biometric authentication process by sensing a biometric characteristic of the finger 506. In this example, the device housing area 602 comprises a substrate 104 and a coating 102 (not shown). The substrate 104 may be configured such that light cannot be transmitted from a display or other light emitting device through the substrate 104. The coating 102 of the device housing area 602 may be an anti-fingerprint coating, or other hydrophobic or oleophobic coating. The coating may also comprise a. Fluorinated silanes and Fluoropolymer, b. Silica-based gels, c. Oxide polystyrene composites, such as Manganese oxide polystyrene (MnO2/PS) composite or Zinc oxide polystyrene (ZnO/PS) composite, d. Precipitated calcium carbonate, e. Carbon nano-tubes, or Durable water repellent or rain repellent. In this example, the finger 506 is touching the device housing area 602 located near the bottom of the mobile device 600, however, in other embodiments, the entire backside of the mobile device 600 may have a substrate 104 and coating 102 to enable improved biometric sensing on the entire backside of the mobile device 600.

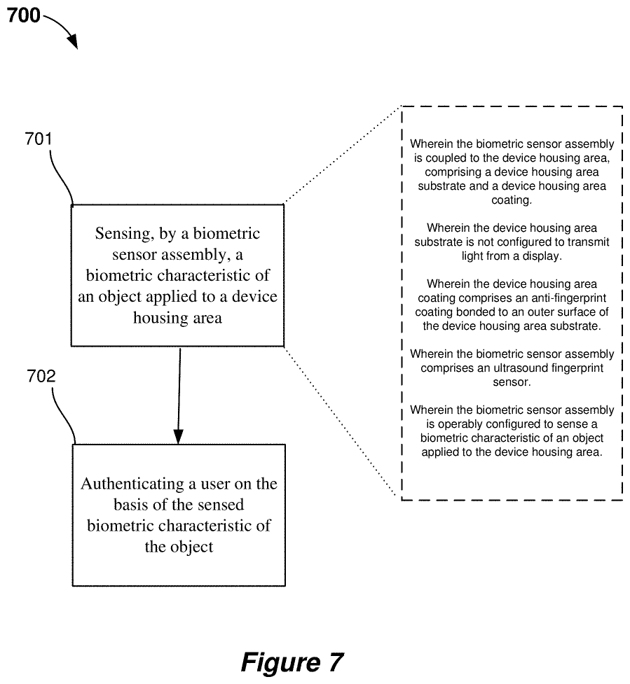

FIG. 7 shows an exemplary flow diagram of a process 700 for sensing a biometric characteristic by a biometric sensor assembly, according to some implementations. The process 700 comprises, at block 701, sensing, by a biometric sensor assembly, a biometric characteristic of an object applied to a device housing area. As described herein, the biometric sensor assembly may be coupled to the device housing area which comprises a substrate and a device housing area coating. The device housing area may be configured to not transmit light from a display—i.e. opaque. The device housing area coating may comprise an anti-fingerprint coating bonded to an outer surface of the device housing area substrate. As described herein, the biometric sensor assembly may comprise an ultrasound fingerprint sensor, and may be operably configured to sense a biometric characteristic of an object applied to the device housing area. At block 701, a user is authenticated on the basis of the sensed biometric characteristic of the object. In this example, and in others, the biometric characteristic may be dermal papillae, a fingerprint, palm print, handprint, blood vessels, bone structure, or sub-epidermal structures.

Thus, an apparatus and method for improved biometric sensing has been disclosed. It will be appreciated that a number of alternative configurations and fabrication techniques may be contemplated.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by or to control the operation of data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, as a person having ordinary skill in the art will readily appreciate, the terms “upper” and “lower”, “top” and bottom”, “front” and “back”, and “over”, “overlying”, “on”, “under” and “underlying” are sometimes used for ease of describing the figures and indicate relative positions corresponding to the orientation of the figure on a properly oriented page, and may not reflect the proper orientation of the device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

What is claimed is:

1. An apparatus for ultrasonic fingerprint sensing, the apparatus comprising:
a device housing area, comprising a device housing area substrate and a device housing area coating;
wherein the device housing area substrate is not configured to transmit light from a display;
wherein the device housing area coating comprises an anti-fingerprint coating bonded to an outer surface of the device housing area substrate; and
a biometric sensor assembly, wherein the biometric sensor assembly comprises an ultrasound fingerprint sensor, and wherein the biometric sensor assembly is operably configured to sense a biometric characteristic of an object applied to the device housing area.

2. The apparatus of claim 1, wherein the device housing area substrate comprises a metal.

3. The apparatus of claim 2, wherein the device housing area substrate comprises an aluminum alloy.

4. The apparatus of claim 3, wherein the device housing area substrate further comprises at least one of an anodized aluminum layer, a titanium aluminum nitride layer, or an aluminum titanium nitride layer.

5. The apparatus of claim 1, wherein the device housing area substrate comprises glass.

6. The apparatus of claim 1, wherein the device housing area substrate comprises a polymer.

7. The apparatus of claim 1, wherein the device housing area substrate comprises ceramic.

8. The apparatus of claim 1, wherein the device housing area coating comprises a hydrophobic or oleophobic coating.

9. The apparatus of claim 8, wherein the device housing area coating comprises at least one of:
a. Fluorinated silanes and Fluoropolymer,
b. Silica-based gels,
c. Oxide polystyrene composites, such as Manganese oxide polystyrene (MnO2/PS) composite or Zinc oxide polystyrene (ZnO/PS) composite,
d. Precipitated calcium carbonate,
e. Carbon nano-tubes, or
f. Durable water repellent or rain repellent.

10. The apparatus of claim 1, wherein the thickness of the anti-fingerprint coating is (2*n+1)*λ/4 or n*λ/2, wherein n is an integer and λ is a wavelength of an emission of the ultrasound fingerprint sensor.

11. The apparatus of claim 9, wherein the thickness of the anti-fingerprint coating is between 100 microns and 200 microns.

12. A method for ultrasonic fingerprint sensing, the method comprising:
sensing, by a biometric sensor assembly, a biometric characteristic of an object applied to a device housing area;
wherein the biometric sensor assembly is coupled to the device housing area, comprising a device housing area substrate and a device housing area coating;
wherein the device housing area substrate is not configured to transmit light from a display;
wherein the device housing area coating comprises an anti-fingerprint coating bonded to an outer surface of the device housing area substrate;
wherein the biometric sensor assembly comprises an ultrasound fingerprint sensor, and wherein the biometric sensor assembly is operably configured to sense a biometric characteristic of an object applied to the device housing area; and
authenticating a user based on the sensed biometric characteristic of the object.

13. The method of claim 12, wherein the device housing area substrate comprises a metal.

14. The method of claim 13, wherein the device housing area substrate comprises an aluminum alloy.

15. The method of claim 14, wherein the device housing area substrate further comprises at least one of an anodized aluminum layer, a titanium aluminum nitride layer, or an aluminum titanium nitride layer.

16. The method of claim 12, wherein the device housing area substrate comprises glass.

17. The method of claim 12, wherein the device housing area substrate comprises a polymer.

18. The method of claim 12, wherein the device housing area substrate comprises ceramic.

19. The method of claim 12, wherein the device housing area coating comprises a hydrophobic or oleophobic coating.

20. The method of claim 19, wherein the device housing area coating comprises at least one of:
a. Fluorinated silanes and Fluoropolymer,
b. Silica-based gels,
c. Oxide polystyrene composites, such as Manganese oxide polystyrene (MnO2/PS) composite or Zinc oxide polystyrene (ZnO/PS) composite,
d. Precipitated calcium carbonate,
e. Carbon nano-tubes, or
f. Durable water repellent or rain repellent.

21. The method of claim 12, wherein the thickness of the anti-fingerprint coating is (2*n+1)*λ/4 or n*λ/2, wherein n is an integer and λ is a wavelength of an emission of the ultrasound fingerprint sensor.

22. The method of claim 20, wherein the thickness of the anti-fingerprint coating is between 100 microns and 200 microns.
